(19) United States
(12) Patent Application Publication
(10) Pub. No.: US 2020/0235526 A1
(43) Pub. Date: Jul. 23, 2020

(54) PLUG

(71) Applicant: LEONI KABEL GMBH, NUERNBERG (DE)

(72) Inventors: KLAUS FALKENBERG, NUERNBERG (DE); SEBASTIAN GOSS, ROTH (DE); JUERGEN HETZNER, GUNZENHAUSEN (DE); ERWIN KOEPPENDOERFER, SCHWABACH (DE)

(21) Appl. No.: 16/488,457

(22) PCT Filed: Feb. 16, 2018
(86) PCT No.: PCT/EP2018/053851

§ 371 Date: Aug. 23, 2019

(30) Foreign Application Priority Data
Feb. 23, 2017 (DE) 10 2017 202 993.5

(51) Int. Cl. H01R 13/6477; H01R 24/44

(52) U.S. Cl. CPC H01R 13/6477; H01R 24/44

(57) ABSTRACT

A plug, in particular a radio-frequency plug, includes a first contact element and a support element (dielectric), so that the first contact element is mechanically guided by the support element. The support element has a permittivity of less than 2. The support element has an aerogel or a foamed plastic or is formed by an aerogel or a foamed plastic.

The invention relates to a plug, preferably a microwave connector, in particular a radio-frequency plug, also referred to below as an RF plug, that has a body, a contact element and a support element made of a dielectric.

The plug is designed in particular as what is known as a coaxial plug. The plug is used for transmitting data, especially at high frequencies of greater than one hundred kHz and especially greater than 1 GHz.

There are numerous different variants of coaxial plugs. These variants all have in common that they have a pin-shaped inner conductor as a first contact element and a sleeve-shaped outer conductor that concentrically surrounds the first contact element as a second contact element. In some variants, such as compact “SMA” plugs for example, an insulating body, i.e. a dielectric, is often arranged between the inner conductor and the outer conductor. The dielectric in this case serves as a support element for a mechanical stabilization of the inner conductor.

To obtain good transmission properties for a radio-frequency electrical signal, the characteristic impedance of the plug should be adapted to the characteristic impedance of a cable connected to it. In addition, it is sought to achieve the highest possible limit frequency, so the plug should be suitable for transmitting frequencies that are as high as possible. Both the characteristic impedance and the limit frequency depend on geometrical factors as well as on the materials selected. For the characteristic impedance and the limit frequency, the known formulas apply:

$$\begin{matrix}fcutoff = \frac{c}{π \cdot ( \frac{D + d}{2} ) \cdot \sqrt{{μ}_{r} {ɛ}_{r}}} und & a ) \\ Z = \frac{60}{\sqrt{{ɛ}_{r}}} \cdot ln ( \frac{D}{d} ) & b )\end{matrix}$$

Where fcutoff=limit frequency, Z=characteristic impedance, D=diameter of the outer conductor, d=diameter of the inner conductor, εΓ=permittivity of the dielectric;

Accordingly, to achieve a predetermined characteristic impedance for a given permittivity of the dielectric, the RF plug has a minimum diameter. The minimum diameter thus limits the possibilities for reducing the volume of the plug. In principle, arranging the dielectric may be dispensed with, in order to achieve the dielectric properties of air within the plug. However, this usually results in a loss of stability, which increases the plug failure rate.

In view of this, the object of the invention is to provide a plug, in particular an RF plug, that has a smaller volume than heretofore commercially-available RF plugs and also has good mechanical stability.

The object is achieved according to the invention by a plug, in particular a radio-frequency plug, that has a body, a first contact element and a support element, so that the first contact element is mechanically guided by the support element, the support element having a permittivity of less than 2. The permittivity is specified here for standard conditions, namely room temperature (18° C.) and a transmitted signal frequency of 50 Hz. These standard conditions apply to all permittivity values given below.

Advantageous configurations, refinements and variants are the subject matter of the dependent claims.

The term “radio frequency” is used here to refer specifically to frequencies of at least 100 kHz and preferably more than 1 GHz or indeed more than 10 GHz. The plug is therefore designed to transmit such frequencies, i.e. its limit frequency is above these frequencies.

The support element generally mechanically supports the first contact element, and for that purpose it is designed as a solid body. In particular, for this purpose, the support element surrounds the first contact element in the form of a sleeve. The support element is preferably arranged around the circumference of the first contact element in a positive-fit manner. The support element is designed as an insulating body and thus as a dielectric. The term “dielectric” herein refers generally to an electrically weakly-conductive or non-conductive, non-metallic material.

In general, signal transmissions via a plug, for example, are lossy. Such losses are, for example, attributable to losses within the conductor material (for example those known as copper losses) and/or to losses due to the permittivity of the dielectric that is arranged inside the plug. Furthermore, the losses are usually structurally correlated with the frequency of the transmitted signal. In other words: The higher the frequency and the higher the permittivity, the greater are the transmission losses.

Because the support element has a permittivity, also known as dielectric conductivity, of less than 2, a dielectric value is achieved that is, for example, below the dielectric value for PTFE (polytetrafluoroethylene) that is used for such insulating bodies. Preferably, the permittivity continues to be less than 1.8 or less than 1.6. This reduces permittivity-related transmission losses. References to the dielectric value, permittivity or dielectric constant refer generally and analogously to the respective permittivity of a substance.

This also increases the plug's limit frequency (cut-off frequency), and this increase has an advantageous effect on the plug's signal transmission behavior.

“Limit frequency” herein refers to a (threshold) frequency that, when exceeded, causes an amplitude of a signal transmitted along a transmission path to fall below a predetermined or required value at the end of the transmission path. The drop in amplitude and the associated signal attenuation are due to destructive superimpositions on the signal that oscillates at a frequency above the cutoff frequency. In other words: The transmission path, usually a plug or a cable, due to its geometry as regards the diameter, is not designed for losslessly transmitting signals with a frequency that exceeds the respective limit frequency. The limit frequency is correlated with the geometry, particularly the diameter, of the plug or cable.

Due to the support element and in particular due to the support element's permittivity being less than 2, it is possible to reduce the volume and thus the plug geometry in comparison to conventional plugs, while providing the same or improved transmission properties. In particular, higher limit frequencies are made possible.

The support element preferably has an aerogel and in particular is formed by an aerogel. “Aerogel” herein refers generally to highly porous solids that have a porosity of at least 80% and in particular at least 95%. In other words: Aerogels are sponge-like solids the volume of which in particular consists of at least 95% pores, and thus air.

Due to the high air content, aerogels have a significantly lower permittivity compared to a solid body made of the same material as the aerogel; as a result, they are extremely advantageous for use as dielectric.

According to one expedient refinement, the aerogel used is a polymer aerogel, in particular a polyimide aerogel. The term “polyimide” refers generally to plastics based on an imide group, for example polysuccinimide (PSI), polyoxadiazobenzimidazole (PBO) or polymethacrylimide (PMI). Such polymer aerogels have advantages over conventional aerogels, for example in terms of their mechanical properties. “Mechanical properties” herein refer especially, by way of example, to strength, workability and water resistance. In particular, strength in combination with low permittivity is an advantage over conventional aerogels with regard to the shock resistance of the support element. This leads to a robust construction of the plug. At this point, for example, special reference should be made to the AeroZero® material from the company Blueshift Materials; the support element is preferably made from this material.

Expediently, the support element, in particular the aerogel, has a permittivity (εΓ) of 1.1 to 1.4. Preferably, the permittivity is less than 1.3 and in particular is 1.18. This value is close to the permittivity of air (εΓ=1). Thus, the support element has almost the same dielectric properties as air, while also having good mechanical support. In addition to good transmission properties, good reliability is also achieved; for example, bending of the plug's first contact element is prevented. At the same time, it is possible for the plug to have a small size.

As an alternative to an aerogel, the support element has a foamed plastic or is formed by a foamed plastic. In this case, the plastic has a high expansion ratio, i.e. high air content. For example, the air content is over 30%, over 50% or over 70% (air volume relative to total volume).

According to one refinement, polytetrafluoroethylene (PTFE) or foamed polyethylene (PE) is used as a foamed plastic.

This configuration is based on the same underlying idea as using an aerogel, namely, to provide the highest possible air content. However, the above-described aerogel, in particular polyimide aerogel, is preferably used, because in this aerogel, good mechanical strength is combined with very low permittivity.

Furthermore, such a configuration, in particular the use of such a dielectric made from an aerogel, is suitable for and transferable to all plugs with a dielectric. In addition, the dielectric made from an aerogel may also be used alternatively or additionally for cables, for example for coaxial cables with an inner conductor, dielectric and outer conductor.

Another preferred aspect in this case is that the support element has a density of less than 1 g/cm³, preferably less than 0.5 g/cm³ and in particular less than 0.2 g/cm³.

The plug is preferably designed as a coaxial plug, i.e. it has an inner conductor (first contact element) and an outer conductor that concentrically surrounds the inner conductor and serves as a second contact element. The support element is arranged in between, which preferably completely fills a space between the inner conductor and the outer conductor. The support element in this case is preferably cylindrical and arranged concentrically around the first contact element. The first contact element is typically designed as a solid pin or as a hollow pin surrounded by the sleeve-shaped outer conductor so as to form the intermediate space. The first contact element, when viewed in a longitudinal direction, typically projects beyond the sleeve-shaped outer conductor. The support element preferably extends in a longitudinal direction to the end of the outer conductor, and in any case, the first contact element protrudes beyond the support element in a longitudinal direction.

Depending on the design of the coaxial plug, the second contact element is preferably a part of the plug's also multi-unit body or housing. Thus, there are some designs in which the plug and mating connector are screwed together or are connectable by means of a (bayonet-type) positive fit connection. In some cases, additional components are furnished for the second contact element (outer conductor), such as for example a union nut or bayonet closure. These additional components are then part of or make up the body.

In this case of additional components, the first contact element, support element and second contact element are preferably concentrically surrounded by the body. The body forms a kind of outer sleeve and serves both to provide mechanical protection and to permit mechanical connection of the plug. For this second purpose, the body generally has mechanical connecting elements, such as for example an internal or external thread or a bayonet closure-type connection. To make screwing more straightforward, the body has, for example, knurling on the outer side or, for example, a hexagonal outer contour.

The plug is generally designed to be connected to a complementary mating connector, in particular a socket. The first, pin-shaped contact element is inserted into a complementary socket sleeve in such a way as to make electrical contact. The socket sleeve in turn forms an inner conductor of the mating connector. This sleeve is surrounded in turn by a sleeve-shaped outer conductor that makes electrical contact with the sleeve-shaped outer conductor of the plug and forms a plug connection, and in particular receives the plug.

An exemplary embodiment of the invention will be explained in greater detail below, with reference to the drawings. The drawings show the following, in highly simplified illustrations:

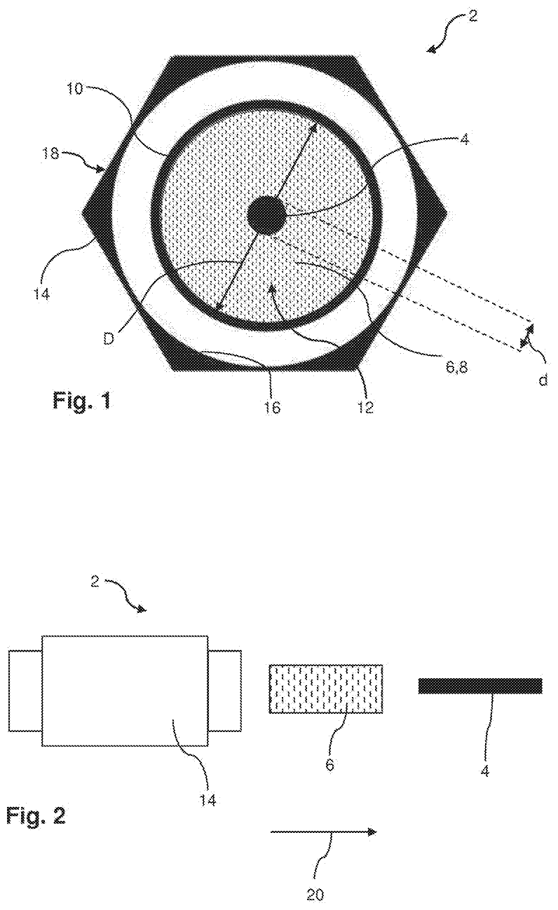

FIG. 1: a front view of a plug, and

FIG. 2: an exploded side view of the plug.

In the drawings, parts that have the same effect are represented by the same reference numerals.

The plug 2 shown in FIGS. 1 and 2 is designed as a coaxial plug, for example for an application in the radio frequency range. The plug 2 has a central first contact element 4 as an inner conductor. The first contact element 4 is concentrically surrounded by a support element 6.

A second contact element 10 is arranged concentrically around the support element 6 and around the first contact element 4. The second contact element 10 forms an outer conductor of the coaxial plug in the exemplary embodiment. This means that the first contact element 4 and second contact element 10 form a space 12 in which the support element 6 is inserted and in the exemplary embodiment completely fills this space.

In the exemplary embodiment, the first contact element 4, support element 6 and second support element 10 are concentrically surrounded by a body 14. In the exemplary embodiment, the body 14 is designed as a union nut. The body accordingly serves to connect or link the plug 2, for example, to a corresponding mating connector (not shown here), which is designed, for example, as a plug or also as a connection to an electrical component, for example an oscilloscope. For this purpose, the body 14, for example, has a number of threads on one inner side 16 by means of which the plug 2 is screwed onto the mating connector. For better manipulability, an outer side 18 of the body 14 has a hexagonal contour. Alternatively or in addition, the outer side 18 has a knurling.

The support element 6 generally forms an insulating body and thus a dielectric. In the exemplary embodiment, the support element is designed as a highly porous body, in particular as an aerogel 8, and in particular as a polyimide aerogel. The support element 6 completely fills the space 12. Viewed in a longitudinal direction 20 (cf. FIG. 2), the support element 6 extends as far as the second contact element 10 (sleeve-shaped outer conductor); in contrast, the pin-shaped inner conductor (first contact element 4) protrudes in a longitudinal direction 20.

In the exemplary embodiment, the aerogel 8 in particular has a permittivity εΓ in the range 1.1 to 1.4. The permittivity εΓ of the support element 6 in the exemplary embodiment corresponds approximately to the permittivity εΓ of air (εΓ=1). In this way, permittivity-related interference with the transmitted signals is reduced.

The advantage of this configuration may be seen in the fact that due to the low permittivity εΓ, the plug 2 may be designed, for example at a predetermined characteristic impedance Z, to be smaller—compared to conventional plugs—and thus to have a smaller diameter D of the second contact element 10 (outer conductor) and a diameter d of the first contact element 4.

It is therefore possible to manufacture a plug 2 with a smaller diameter D than conventional plugs without disadvantageously impacting the signal transmission properties, for example the limit frequency or characteristic impedance. Meanwhile, the support element 6 retains its support function for mechanically stabilizing and guiding the first contact element 4, so that this element is protected against unintentional folding or bending, for example when plugging in the plug 2.

Alternatively to the aerogel 8, the support element 6 has a foamed plastic, for example a foamed PTFE or foamed PE, and in particular is formed therefrom.

FIG. 2 shows as a sketch of an exploded view of the plug 2. FIG. 2 shows, by way of example, the plug 2 before final assembly. In this case, for example, the first contact element 4 is inserted into the support element 6, for example to form a press fit. The support element 6 arranged concentrically around the first contact element 4 is then, or also previously, inserted into the second contact element 10, preferably likewise to form a press fit. Around the second contact element 10, the body 14 is arranged, which is designed as a union nut.

The invention is not limited to the exemplary embodiments described above. The skilled person will also be able to derive other variants of the invention without departing from the subject matter of the invention. In particular, all the individual features described in connection with the exemplary embodiments may also be combined together in other ways without departing from the subject matter of the invention.

1-10. (canceled)

11. A plug or a radio-frequency plug, comprising a first contact element and a support element so that the first contact element is mechanically guided by the support element, the support element having a permittivity of less than 2.

12. The plug according to claim 11, wherein the support element has an aerogel or is formed by an aerogel.

13. The plug according to claim 12, wherein a polymer aerogel is used as the aerogel.

14. The plug according to claim 12, wherein a polyimide aerogel is used as the aerogel.

15. The plug according to claim 14, wherein the support element has a permittivity in the range from 1.1 to 1.4.

16. The plug according to claim 11, wherein the support element has or is formed by a foamed plastic.

17. The plug according to claim 16, wherein a foamed PTFE or foamed PE is used as the foamed plastic.

18. The plug according to claim 11, wherein the support element has a density of less than 1 g/cm³, preferably less than 0.5 g/cm³ and in particular less than 0.2 g/cm³.

19. The plug according to claim 11, wherein the first contact element is formed in the manner of a pin that is surrounded circumferentially by the support element.

20. The plug according to claim 19, wherein the support element fills a space between the first and second contact elements.
